(19) United States
(12) Patent Application Publication
(10) Pub. No.: US 2015/0009323 A1
(43) Pub. Date: Jan. 8, 2015

(54) MULTI-TARGET TRACKING METHOD FOR VIDEO SURVEILLANCE

(71) Applicant: Zmodo Technology Shenzhen Corp. Ltd, Shenzhen (CN)

(72) Inventor: Ming LEI, Shenzhen (CN)

(73) Assignee: Zmodo Technology Shenzhen Corp. Ltd, Shenzhen (CN)

(21) Appl. No.: 14/075,531

(22) Filed: Nov. 8, 2013

(30) Foreign Application Priority Data
Jul. 3, 2013 (CN) 201310277394.0

(51) Int. Cl. H04N 7/18

(52) U.S. Cl. CPC H04N 7/183
USPC 348/143

(57) ABSTRACT

The invention discloses a new multi-target tracking method for video surveillance. The main steps include obtaining target state from previous frame, detecting target in current frame (observation), computing cost matrix between all existing targets and observations and solving the assignment problem by EMD (earth movers distance) algorithm. As have obtained correspondence between all existing objects and observations, then track them separately. The proposed method includes 4 modules: target state maintaining module, used to save all target's state in previous frame, object detection module, used to detect all objects in current frame, EMD algorithm module, using EMD algorithm to solve correspondence problem for multi-target tracking, object processing module, which using the result of EMD algorithm to process all existing and new objects. Experiments demonstrated the effectiveness of this method, which improves the accuracy for multi-target tracking.

### TECHNICAL FIELD

In this invention, a multi-target tracking method for video surveillance is proposed, which belongs to smart video surveillance domain.

### BACKGROUND

Multi-target tracking is one of most important step for smart video surveillance, for dense targets, it's still a challenge. The key point of multi-target tracking is data association, existing solutions include local nearest neighbor association, global nearest neighbor association, multi-hypothesis tracking, and joint probability data association, which are widely used in radar and sonar target tracking.

As the complexity of information, all existing methods are not able to handle multi-target tracking problem effectively in computer vision domain.

### SUMMARY

In order to track multi-target accurately for smart video surveillance, a new multi-target tracking algorithm is proposed.

The method comprises the following steps:

Obtain all existing target's state in previous frame;

Detect all objects in current frame and get their observation value;

Construct cost matrix from target sate and observation, solve it using EMD algorithm and get the assignment matrix;

Process the assignment matrix and track each target separately, including new target.

The details of obtain target state are as follow:

Process each existing target using non-linear filter, predict their position and size in current frame.

Detect all objects in current frame,

Compute cost matrix from target state and observations, details are as follow:

Compute position distance, size distance, and histogram distance between each existing target and detected observation. Sum these distance, thus form the element of cost matrix.

Solve cost matrix using EMD algorithm and get the assignment matrix.

Use the assignment matrix to track each existing and new target separately. All objects are classified as new target, disappeared target, occluded and isolated one.

The method to handle new target entry is as follow:

Find the maximum element for each column in assignment matrix, and compare it with a user defined threshold, if it is greater than the threshold value, it's a new object, and initialize state.

The method to handle target exit is as follow:

Find the maximum element for each row in assignment matrix, if the element is less than a user defined threshold, then increment the disappear count. If it's disappear count is greater than a threshold, delete the target.

The method to handle target occlusion is as follow:

Compute the number of element which is greater than a threshold;

If the number is 1, update the state of target using the corresponding observation;

If the number is greater than 1, the occlusion occurs, and update target state using these corresponding observations.

A multi-target tracking method for video surveillance, the main steps include:

Target acquisition module, used to obtain target state in previous frame;

Object detection module, used to detect all targets in current frame and get their state;

Correspondence computation module, which uses target state and observation state to construct cost matrix, solves it using EMD algorithm and the result is an assignment matrix;

Recognition module, used to handle each target separately from the assignment matrix.

Additionally, the method includes following modules:

Prediction module, used to predict the state of existing target in current time, including position, size and color histogram.

Correspondence computation module computes position distance and size distance, histogram distance between each existing target and detected observation. Sum these distances, thus form the element of cost matrix.

Use assignment matrix to handle new object entry, target exit, and target occlusion.

The method to handle new target entry is as follow:

Find the maximum element for each column in assignment matrix, and compare it with a user defined threshold. If it is greater than the threshold value, it's a new object, and initialize state for it.

The method to handle target exit is as follow:

Find the maximum element for each row in assignment matrix, if the element is less than the threshold, increment the disappear count. If it's disappear count is greater than a threshold, delete the target.

The method to handle target occlusion is as follow: Compute the number of element which is greater than a threshold value;

If the number is 1, update the state of target using the corresponding observation;

If the number is greater than 1, occlusion occurs, update target state using these corresponding observations.

The proposed method detects target in each frame, computes cost matrix for them, and establishes correspondences of target between adjacent frames using EMD algorithm. Experiments demonstrated the effectiveness of the method, which improves the accuracy of tracking considerately.

### BRIEF DESCRIPTION OF THE DRAWINGS

FIG. 1 is a flowchart of a multi-target tracking method for video surveillance in accordance with an embodiment of the present invention.

FIG. 2 is a flowchart of a method for constructing cost matrix from target sate and observation and solving the cost matrix using EMD algorithm to get an assignment matrix.

FIG. 3 is a flowchart for processing disappearance of the target in current frame according to elements in the assignment matrix in accordance with the embodiment of the present invention.

FIG. 4 is a flowchart for processing occurrences of the occlusion of the target in current frame according to elements in the assignment matrix in accordance with the embodiment of the present invention.

FIG. 5 is a schematic diagram of the structure of multi-target tracking device for video surveillance in accordance with the embodiment of the present invention.

FIG. 6 is a schematic diagram of the structure of multi-target tracking device for video surveillance in accordance with another embodiment of the present invention.

FIG. 7 is a schematic diagram of the structure of computing module in accordance with the embodiment of the present invention.

FIG. 8 is a schematic diagram of the structure of recognition module in accordance with the embodiment of the present invention.

FIG. 9 is a schematic diagram of the structure of recognition module in accordance with another embodiment of the present invention.

### DETAILED DESCRIPTION OF THE PREFERRED EMBODIMENTS

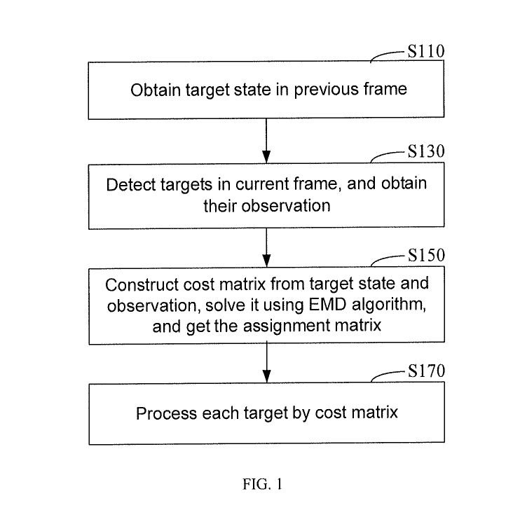

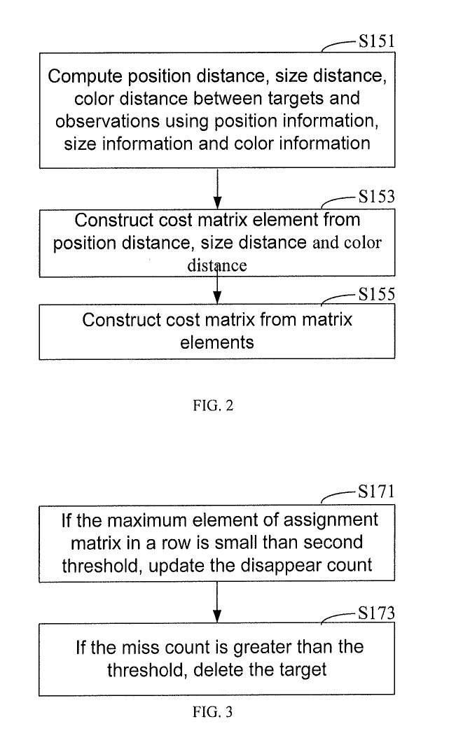

As shown in FIG. 1, the multi-target tracking algorithm includes the following steps:

Step S110 obtains all existing target's state in current frame, including position, size and color state.

The details of step S110 are as follow:

For each existing target, using non-linear filter to predict their state, in current implementation, particle filter is used.

The target state includes position (x, y), size (w, h), and color histogram.

In step S130, detect all targets in current frame. The candidate object detection schemes include motion based methods, such as Gaussian mixture model, classifier based methods, such as Haar and Adaboost method, histograms of oriented gradients and support vector machine method, and so on. As has detected all targets, state is computed, the state is called observation, including position, size and color histogram. However, there exists missed detection and false alarm.

In step S150, compute cost matrix from target state and observation, and solve it using EMD algorithm, the result is assignment matrix, which represents correspondence between each existing target and observation.

The details of step S150 are as follow:

Step S151 uses each existing target and observation's position, size, and color histogram to compute their distance.

In the method, the state of existing target includes (xₚᵣₑᵥ, yₚᵣₑᵥ, wₚᵣₑᵥ, hₚᵣₑᵥ)ᵢ, and hist_{prev,i}, (xₚᵣₑᵥ, yₚᵣₑᵥ)ᵢ is ith target's position, (wₚᵣₑᵥ, hₚᵣₑᵥ)ᵢ is size, hist_{prev,i} is color histogram.

The observation representing state of target in current frame includes (x_{cur}, y_{cur}, w_{cur}, j_{cur})ⱼ and hist_{cur,j}, identically (x_{cur}, y_{cur})ⱼ is jth target's position, (w_{cur}, h_{cur})ⱼ is size, and hist_{cur,j} is color histogram.

The position distance between ith target and jth observation is defined as:

Dₚₒₛ(i, j)=\sqrt{(x_{prev,i}−x_{cur,j})²+(y_{prev,i}−y_{cur,j})²}

Similarly, the size distance is defined as:

D_{size}(i, j)=\sqrt{(w_{prev,i}−w_{cur,j})²+(h_{prev,i}−h_{cur,j})²}

Color distance is defined as:

$${D}_{hist} ( i , j ) = \sqrt{1 - {\sum }_{k = 1}^{n} {h}_{i , k} \cdot {h}_{j , k}}$$

Where n is the size of color histogram, h_{i,k} is normalized component.

In step S153, sum position distance, size distance, and histogram distance, the result is the element of cost matrix.

If the number of existing in previous frame is m, the number of observation in current is n, a m×n cost matrix are constructed, and is used by EMD algorithm, which is defined as:

M_{i,j}=αDₚₒₛ(i, j)+βD_{size}(i, j)+γDₕᵢₛₜ(i, j)

Where α, β and γ are used defined Coefficients between [0, 1], and the sum of them is 1.

In step S155, the method uses the distance value to form cost matrix.

Solve the cost matrix by EMD algorithm and got a assignment matrix f, the element f_{i, j} represents the correlation between ith target and jth observation, which is between [0, 1].

In step S170, process each target and observation separately.

In some surveillance scenes, targets split, merge, and occlude frequently. Using assignment matrix, these problems are solved accurately.

In order to process new targets, find the maximum element for each column in assignment matrix, and compare it with a user defined threshold t_{new}, if it is greater than t_{new}, it's a new object, and initialize state.

In step S171, the method to handle target exit is as follow:

Firstly, find the maximum element for each row in assignment matrix, if the element is less than the threshold tₑₓᵢₛₜ, increment the disappear count. If the disappear count is greater than a threshold, delete the target, this is implemented in step S173.

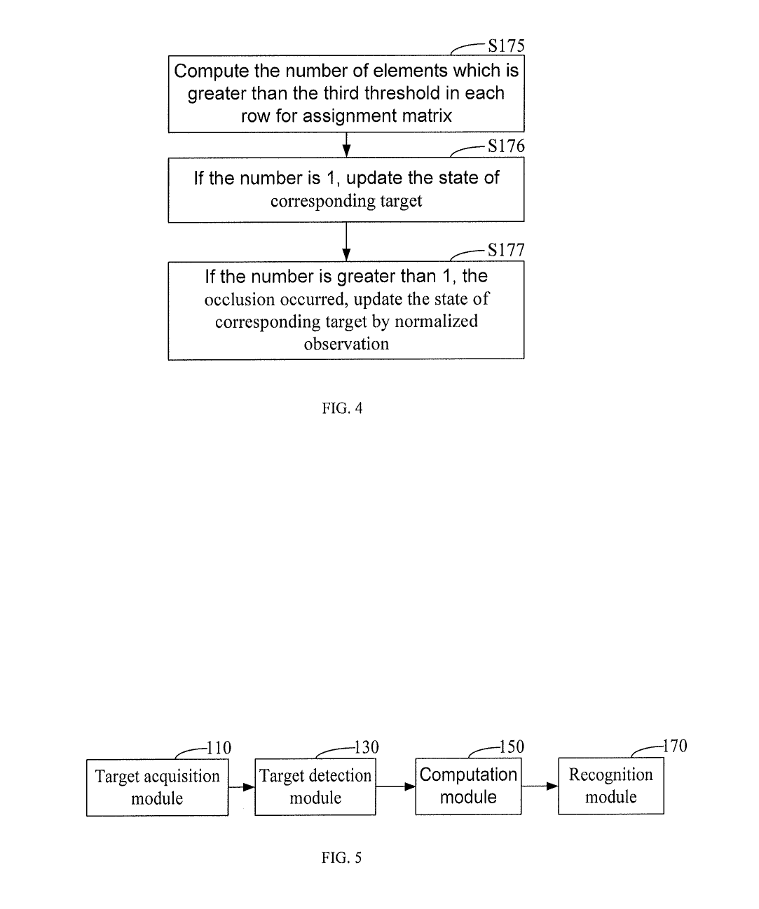

As shown in FIG. 4, the method to handle target occlusion is as follow:

Step S175: compute the number of element which is greater than a threshold t;

Step S176: If the number is 1, update the state of target using the corresponding observation. The histogram is updated as follow:

hist_{new}(1−α)histₚᵣₑᵥ+α·hist_{cur}

Where histₚᵣₑᵥ is the histogram in previous frame, hist_{cur} is the histogram of observation in current frame, hist_{new} is new histogram, α is a user defined value which between [0, 1].

Step S177: if the number is greater than 1, occlusion occurs, update target state using these corresponding observations.

If the elements greater than threshold are f_{i,1}, . . . , f_{i,s}, normalize them and got w₁, . . . , wₛ, then use their corresponding observation j₁, . . . , jₛ to update target state. The histogram is updated as follow:

$${hist}_{new} = ( 1 - α ) {hist}_{prev} + α \cdot {hist}_{cur \_ mean}$$

$${hist}_{cur \_ mean} = {\sum }_{i = 1}^{s} {w}_{i} \cdot {hist}_{cur , i}$$

Where hist_{cur,i} is the histogram of ith observation, wᵢ is normalized match factor.

Using EMD algorithm, the method handles new target entry, target exit, target occlusion conveniently,

As shown in FIG. 5, the tracking algorithm includes obtaining module 110, object detection module 130, computation module 150, and recognition module 170.

The obtaining module 110 is used to obtain target state in previous frame and predict it in current frame. The state includes position, size, and color information.

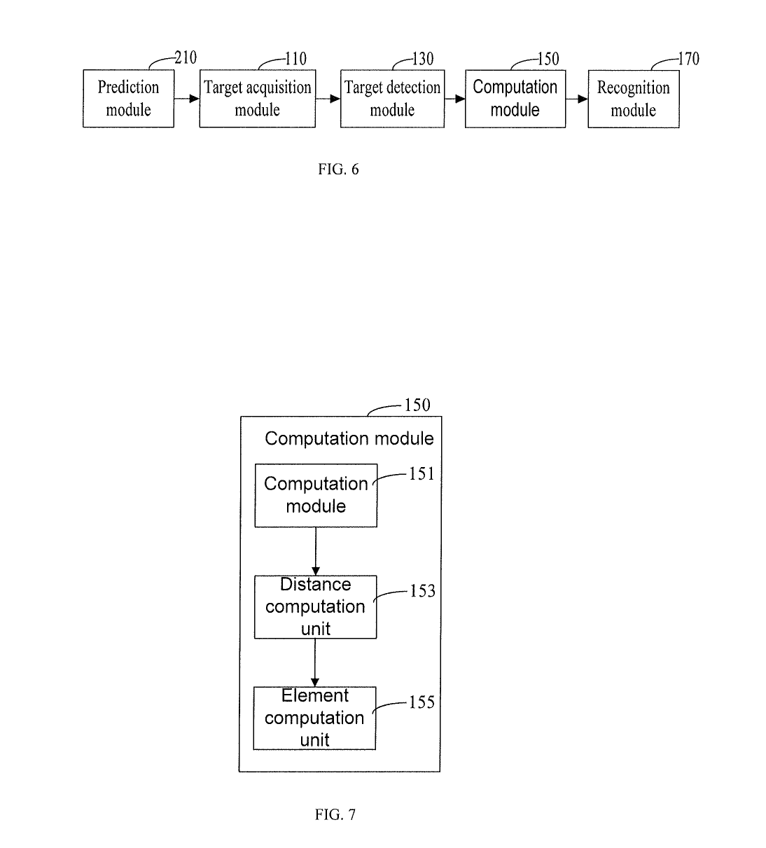

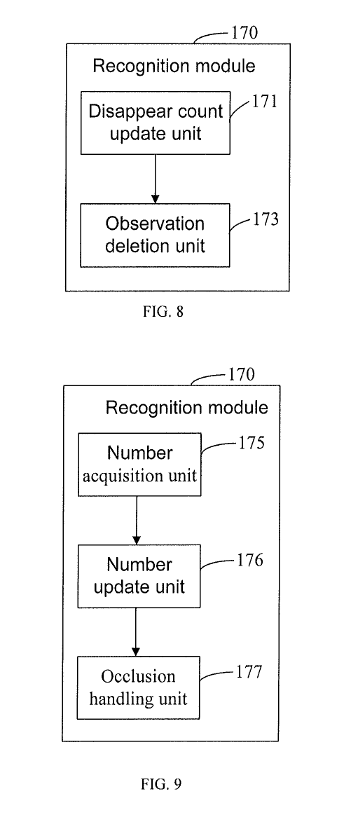

As shown in FIG. 6, the algorithm also includes module 210, the prediction module.

Module 210 is used to predict all existing target's state in current frame, including position, size and color histogram.

In current implementation, particle filter is used. As a predictor, particle filter predict the position and size of each target, Position is represented as a point (x, y) in image coordinate, size is represented as (w, h), where w is width and h is height. Color histogram is used to describe the appearance of target.

Object detection module 130 is used to detect all objects in current frame and get their state.

In current implementation, different scheme are be used, such as motion based methods (for example, Gaussian mixture background model), classifier based methods (for example, Haar Adaboost and HOG SVM). The output of object detector is a list of rectangles, from these rectangles, the method gets the position, size and color histogram for each object. However, there exists problem such as missing detection, false alarm for all methods.

Computation module 150 is used to construct cost matrix from target state and observation and solve it by EMD algorithm.

Module 150 includes distance computation unit 151, element computation unit 153, and matrix construction unit 155.

Distance computation unit 151 is used to compute distance between each target and observation. In the method, it includes position distance, size distance, and histogram distance.

The state of ith target is represented as (xₚᵣₑᵥ, yₚᵣₑᵥ, wₚᵣₑᵥ, hₚᵣₑᵥ)ᵢ and hist_{prev,i}, where (xₚᵣₑᵥ, yₚᵣₑᵥ)ᵢ is position predicted in current frame, (wₚᵣₑᵥ, hₚᵣₑᵥ)ᵢ is size, and hist_{prev,i} is histogram.

The jth observation in current is represented as (x_{cur}, y_{cur}, w_{cur}, h_{cur})ⱼ and hist_{cur,j}, identically, (x_{cur}, y_{cur})ⱼ, (w_{cur}, h_{cur})ⱼ, hist_{cur,j} are position, size and histogram respectively.

Unit 151 computes position distance as follow:

Dₚₒₛ(i, j)=\sqrt{(x_{prev,i}−x_{cur,j})²+(y_{prev,i}−y_{cur,j})²}

Size distance is computed as:

D_{size}(i, j)=\sqrt{(w_{prev,i}−w_{cur,j})²⇄(h_{prev,i}−h_{cur,j})²}

Histogram distance is computed as:

$${D}_{hist} ( i , j ) = \sqrt{1 - {\sum }_{k = 1}^{n} {h}_{i , k} \cdot {h}_{j , k}}$$

Where n is the size of histogram, h_{i,k} is normalized component.

Unit 153 constructs distance from the output of unit 151, the distance is defined as:

M_{i,j}=αDₚₒₛ(i, j)+βD_{size}(i, j)+γDₕᵢₛₜ(i, j)

Where M_{i,j} is the distance between ith target and jth observation, also, it's the element of cost matrix in row i and column j. And α, β and γ are used defined Coefficients between [0, 1], and the sum of them is 1. The construction of matrix is implemented by unit 155.

The cost matrix is solved using EMD algorithm and the output is the assignment matrix, all elements of which are between [0, 1]. These elements represent Matching Degree between target and observation.

Recognition module 170 is used to track each target separately from assignment matrix. In order to tack each target correctly, target split, merge, and occlusion must be handled. Additionally, the method should recognize new target entry and target exit.

the method to handle target exit is as follow:

In order to process new targets, find the maximum element for each column in assignment matrix, and compare it with a user defined threshold t_{new}, if it is greater than t_{new}, it's a new object, and initialize state.

The method to handle target exit is as follow:

Firstly, find the maximum element for each row in assignment matrix, if

the element is less than the threshold tₑₓᵢₛₜ, increment the disappear count. If it's disappear count is greater than a threshold, delete the target.

Disappear count is implemented by unit 171 and deletion of target is implemented by unit 173.

The method to handle target occlusion is as follow:

Unit 175: compute the number of element which is greater than a threshold t;

Unit 176: If the number is 1, update the state of target using the

corresponding observation. The histogram is updated as follow:

hist_{new}=(1−α)histₚᵣₑᵥ+α·hist_{cur}

Where histₚᵣₑᵥ is the histogram in previous frame, hist_{cur} is the histogram of observation in current frame, hist_{new} is new histogram, α is a user defined value which between [0, 1].

Unit 177: if the number is greater than 1, occlusion occurs, we update target state using these corresponding observations.

If the elements greater than threshold are f_{i,1}, . . . , f_{i,s}, normalize them and the normalized value is w₁ . . . , wₛ, then use their corresponding observation j₁, . . . , jₛ to update target state. The histogram is updated as follow:

$${hist}_{new} = ( 1 - α ) {hist}_{prev} + α \cdot {hist}_{cur \_ mean}$$

$${hist}_{cur \_ mean} = {\sum }_{i = 1}^{s} {w}_{i} \cdot {hist}_{cur , i}$$

Where hist_{cur,i} is the histogram of ith observation, wᵢ is normalized match factor.

The method described above resolve new target entry, target exit and occlusion accurately, through assignment matrix constructed by EMD algorithm.

The proposed method uses object detection algorithm to detect target in video frame, and EMD algorithm to solve the data association problem. Compared with existing association method, EMD algorithm handle target occlusion more effectively, so it's suitable for target tracking in video surveillance, especially dense targets.

The person skilled in this art can understand that all the steps or parts of the steps of the method of the above described invention are realized by the relative hardwares controlled by computer program. The program is stored in a computer readable storage medium, when the program is implemented, the flowchart of the method described above is includes. Wherein the readable storage medium can be magnetic disk, compact disk, read-only memory (ROM), or random access memory (RAM).

The above described examples are only a few embodiments of the present invention, and the descriptions are detailed, but it should not be understood that they are not intended to limit the invention to these embodiments. It should be noted that, to the person skilled in this art, the alternatives, modifications and equivalent to the embodiments may be included within the spirit and scope of the invention. Therefore, the extent of protection of the present invention shall be determined by the attached claims.

1. A multi-target tracking method for video surveillance, which includes the following steps:
obtaining target state in previous frame;
detecting object in current frame and obtaining all observations in current time;
computing cost matrix between each object and observation;
solving cost matrix using EMD algorithm, the result is the assignment matrix for all existing objects and observations;
processing all targets and observations separately.

2. The method as claimed in claim 1, wherein the step of obtaining target state in previous frame comprises: Process all existing targets using non-linear filter, predict their state, including target position, size and color histogram.

3. The method as claimed in claim 1, wherein the step of detecting object in current frame and obtaining all observations in current time comprises:
detecting all objects in current frame, and computing their state, including position, size, and color histogram.

4. The method as claimed in claim 3, wherein the step of computing cost matrix between each object and observation comprises: computing position distance, size distance, histogram distance between each existing object and observation, sum these distance to get the cost matrix, Each element in this matrix represents the distance between an object and observation.

5. The method as claimed in claim 1, wherein the step of solving cost matrix using EMD algorithm, thus obtain the assignment matrix for all existing objects and observations comprises:
solving the cost matrix, the result is the assignment matrix, the elements of which represent the correspondence between each existing object and observation,
processing each existing object and observation, handle new target entry, target exit, target occlusion.

6. The method as claimed in claim 5, wherein the method to handle new target entry is as follow:
finding the maximum element for each column in assignment matrix, and compare it with a user defined threshold, if it is greater than the threshold value, it's a new object, and initialize state for it.

7. The method as claimed in claim 5, wherein the method to handle target exit is as follow:
finding the maximum element for each row in assignment matrix, if the element is less than the threshold, increment the disappear count, If it's disappear count is greater than a threshold, delete the target.

8. The method as claimed in claim 5, wherein the method to handle target occlusion is as follow:
computing the number of element which is greater than a threshold;
updating the state of target using the corresponding observation if the number is 1;
if the number is greater than 1, the occlusion occurs, update target state using these corresponding observations.

9. A multi-target tracking device for video surveillance, comprising:
a target obtaining module, used to obtain all target's state in previous frame;
an object detection module, used to detect all objects in current and get their state;
a correspondence computing module, which use target state and observation state to compute cost matrix, solve the matrix using EMD algorithm and the result is an assignment matrix;
a recognition module, used to track each target separately from the assignment matrix.

10. The device as claimed in claim 9, wherein the target obtaining module uses non-linear filter to predict the state of each existing target, which includes position, size, and color histogram.

11. The device as claimed in claim 9, wherein the object detection module uses object detection algorithm such as background model or classifiers to detect all objects in current frame, and uses object detection results to obtain their state, including position, size, and color histogram.

12. The device as claimed in claim 11, wherein the distance computing module computes distance between each existing object and observation, including position distance, size distance, histogram distance, these distance values are element of cost matrix.

13. The device as claimed in claim 9, wherein the EMD algorithm is used to solve the correspondence problem, the input of which is cost matrix and the output is assignment matrix, which is used to solve new object entry, target exit, target occlusion.

14. The device as claimed in claim 13, wherein the method to handle new target entry is as follow:
finding the maximum element for each column in assignment matrix, and compare it with a user defined threshold, if it is greater than the threshold, it's a new object, and initialize state for it.

15. The device as claimed in claim 13, wherein the method to handle target exit is as follow:
finding the maximum element for each row in assignment matrix, if the element is less than the threshold, increment the disappear count, if it's disappear count is greater than a threshold, delete the target.

16. The device as claimed in claim 13, wherein the method to handle target occlusion is as follow:
computing the number of element which is greater than a threshold;
if the number is 1, updating the state of target using the corresponding observation;
if the number is greater than 1, the occlusion occurs, updating target state using these corresponding observations.
